(19) United States
(12) Patent Application Publication
(10) Pub. No.: US 2026/0329844 A1
(43) Pub. Date: Oct. 22, 2026

(54) SYSTEMS AND METHODS FOR CATALOG MANAGEMENT

(71) Applicant: NationsBenefits, LLC, Plantation, FL (US)

(72) Inventors: Glenn Marc PARKER, Ft. Lauderdale, FL (US); Michael Ethan PARKER, Miami, FL (US); Robert Paul HABLUTZEL, Pittsboro, NC (US); Grahame Andrew JASTREBSKI, San Jose, CA (US)

(21) Appl. No.: 19/183,711

(22) Filed: Apr. 18, 2025

(51) Int. Cl. G06F 16/23; G06F 16/25

(52) U.S. Cl. CPC G06F 16/2365; G06F 16/258

(57) ABSTRACT

Methods, systems, and media are provided for catalog management. An example method comprises: receiving a first data structure comprising one or more items in a non-standardized format; determining a map between the first data structure and a second data structure stored in the database; converting, based on the determined map, each item of the first data structure to a standardized format, the conversion stored in a third data structure; determining a difference between the second data structure and the third data structure, the difference stored in a fourth data structure; determining, using a machine learning model, an update to the fourth data structure; updating the fourth data structure; and updating the second data structure based on the updated fourth data structure.

### TECHNICAL FIELD

Embodiments of this disclosure relate to systems and methods for catalog management.

### BACKGROUND

Electronic catalogs contain many gigabytes or even terabytes of data relating to a listing of goods or services. Some electronic catalogs may include data for disparate goods and services for many different retailers. Storing and maintaining such electronic catalogs is a resource- and time-intensive process due to the vast number of data entries, potential data mismatches, opaque or cryptic abbreviations, etc. For example, when a same item is stored as multiple entries due to different retailers'categorization of the item, the redundant entries result in wastes in data storage space and confusing misrepresentations of the item.

Further, this immense cache of data may require updates. The updates may originate from any number of different sources with different formatting. For example, sources may use many custom abbreviations or code systems for items that are often difficult to understand or interpret. Further, different sources may refer to same or similar items with different names, labels, or categories. Updating and maintaining an electronic catalog present a huge technical problem due to the vast number and frequency of updates and items, which can often lead to data mismatches or redundancies. Current methods for updating catalogs using data from different sources using different formats require a lot of time and manual review and are error prone. Further, current methods for updating catalogs are ill-equipped to handle data that is fragmented, incorrect, or inconsistent, oftentimes requiring manual intervention, thereby ruining the efficiency of such methods.

It is accordingly a primary object of the disclosed embodiments to solve these problems as well as many others (e.g., similar problems associated with database management).

### BRIEF SUMMARY

Embodiments of the present disclosure are directed to methods, systems, and computer-readable media for catalog management. An example method comprises: receiving a first data structure comprising one or more items in a non-standardized format; determining a map between the first data structure and a second data structure stored in the database; converting, based on the determined map, each item of the first data structure to a standardized format, the conversion stored in a third data structure; determining a difference between the second data structure and the third data structure, the difference stored in a fourth data structure; determining, using a machine learning model, an update to the fourth data structure; updating the fourth data structure; and updating the second data structure based on the updated fourth data structure.

Systems and computer readable media (such as non-transitory computer-readable media) that implement the above method are also provided.

Additional objects and advantages of the embodiments will be set forth in part in the description which follows, and in part will be obvious from the description, or may be learned by practice. The objects and advantages will be realized and attained by means of the elements and combinations particularly pointed out in the appended claims.

It is to be understood that both the foregoing general description and the following detailed description are examples and explanatory only and are not restrictive of the claims.

### BRIEF DESCRIPTION OF THE SEVERAL VIEWS OF THE DRAWINGS

The accompanying drawings, which are incorporated in and constitute a part of this specification, illustrate several embodiments and together with the description, serve to explain some principles.

FIG. 1 is an example system for use in implementing disclosed embodiments.

FIG. 2 is an example process for catalog management, consistent with disclosed embodiments.

FIG. 3A is an example diagram of a data structure in a non-standardized format, consistent with disclosed embodiments.

FIG. 3B is an example diagram of a data structure in a standardized format, consistent with disclosed embodiments.

FIG. 4 is a flowchart for an example catalog management method, consistent with disclosed embodiments.

### DETAILED DESCRIPTION

Reference will now be made in detail to various embodiments, examples of which are illustrated in the accompanying drawings. Wherever possible, the same reference numbers will be used throughout the drawings to refer to the same or like parts.

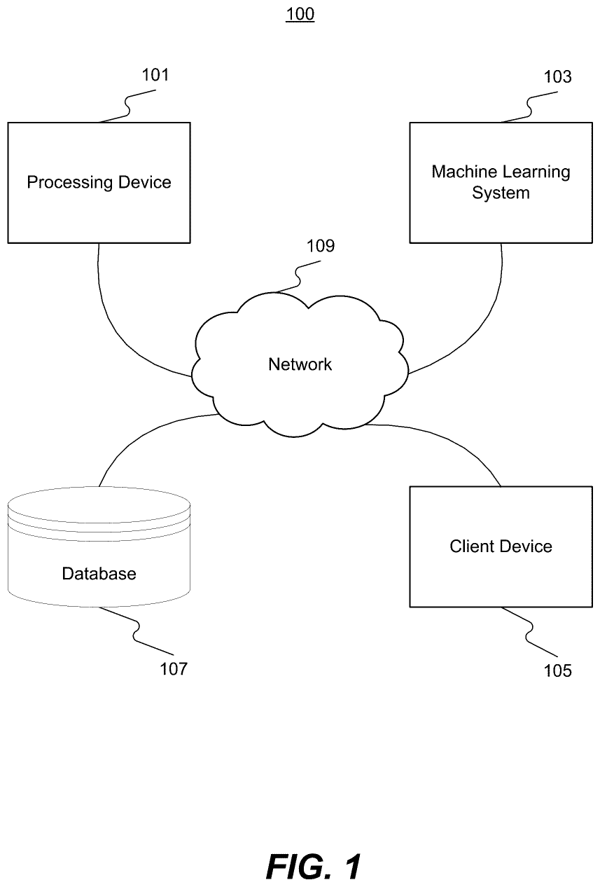

FIG. 1 is a system 100 for use in implementing the disclosed embodiments. System 100 comprises processing device 101, machine learning system 103, client device 105, database 107, and network 109.

In one non-limiting example, a retailer may participate in a spending program. The retailer may use client device 105 to provide a full catalog of all products and/or services to an operator of the spending program. The operator of the spending program may use processing device 101 to analyze the received catalog (further discussed below), including determining, with or without assistance from machine learning system 103, a map between the received catalog and a master catalog (further discussed below) stored in database 107. Processing device 101 may update the master catalog with new or updated items from the received catalog. The retailer can then access the master catalog during transactions to determine program eligibility. A spending program may include a system configured to provide a user or a member with designated or allocated funds for specific spending purposes based on one or more program rules. For example, a spending program may include a flexible spending account, a health savings account, a benefits account, or any other spending program.

In some embodiments, each device illustrated in FIG. 1 may be operated or administered by separate parties. However, in other embodiments, one party may operate or administer more than one of the devices illustrated in FIG. 1. For example, a single entity may operate any or all of processing device 101, machine learning system 103, database 107, and network 109. Additionally, in some embodiments, one of the illustrated devices in FIG. 1 may be combined with another illustrated device. For example, processing device 101, machine learning system 103, client device 105, and database 107 may be combined into a single device, may be divided up amongst a set of electronic devices, or some combination thereof. One of ordinary skill will understand that particular devices in system 100 can be duplicated, omitted, or modified, as appropriate. For example, processing device 101 may communicate directly with client device 105 without network 109 (e.g., via wired connection). The example components and arrangements as shown in FIG. 1 are not intended to limit the disclosed embodiments.

Processing device 101 represents one or more electronic devices configured to perform an operation or a task. For example, processing device 101 may include or one or more known processing devices, such as, for example, a microprocessor. In some embodiments, processing device 101 may include any type of single or multi-core processor, mobile device microcontroller, central processing unit, or any circuitry that performs logic operations. In operation, processing device 101 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in processing device 101 (e.g., in at least one non-transitory computer-readable medium), or elsewhere.

In some embodiments, processing device 101 may be configured to receive a first data structure comprising one or more items in a non-standardized format. For example, a retailer may send, using client device 105, the first data structure to processing device 101 via a secure file transfer protocol (SFTP). Additionally or alternatively, a retailer may send, using client device 105, the first data structure to processing device 101 via a web-based portal, electronic mail, or any other suitable electronic communication method.

In some embodiments, the first data structure may include an initial full catalog file. An initial full catalog file may refer to a single file or data structure that includes all items (e.g., product, service) that may be sold or have the potential to be eligible for purchase with a particular spending program and associated information. For example, an initial full catalog may be a data structure comprising data for each product or service provided by a particular retailer in a non-standardized format. The non-standardized format may be a data format associated with a particular retailer and may differ from the standardized format of the second catalog (further discussed below).

In some embodiments, the first data structure may include a catalog update file. A catalog update file may refer to a single file or data structure that includes one or more updates to the initial full catalog file. For example, the catalog update file may include a list of updated items that may be sold or have the potential to be eligible for purchase with a particular spending program and associated information. The updates may include new items and/or updates to previous items—including any changes to item code, item description, or any other data associated with an item. Further, a catalog update may be a data structure comprising updated (e.g., new, removed, updated) data for each product or service provided by a particular retailer in a non-standardized format (further discuss below).

In some embodiments, the catalog update file may be a full catalog update file. A catalog update file may comprise all items, including the updated items. For example, a catalog update may be a data structure or file that includes all the items (e.g., products, services) provided by a retailer and may differ from an initial full catalog with respect to the data associated with updated items (e.g., new items, removed items, updated items). Additionally or alternatively, in some embodiments, the catalog update file may be a delta catalog update file. A delta catalog update file may comprise only updated items. For example, a delta catalog update may be a data structure that includes a subset of the items (e.g., products, services) provided by a retailer. The subset may include only updated items, which may include new items, items to be removed, and/or items with one or more data values changed (e.g., updated item code).

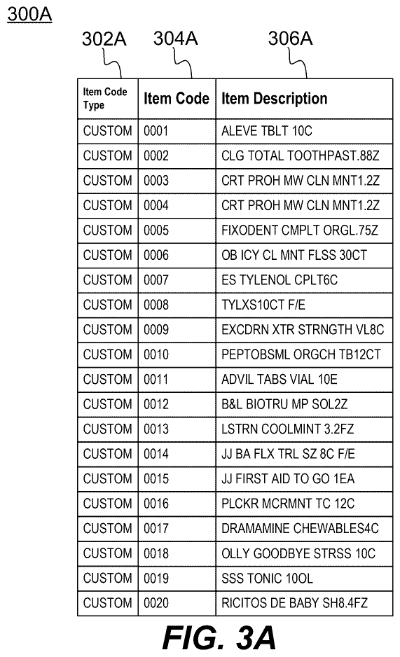

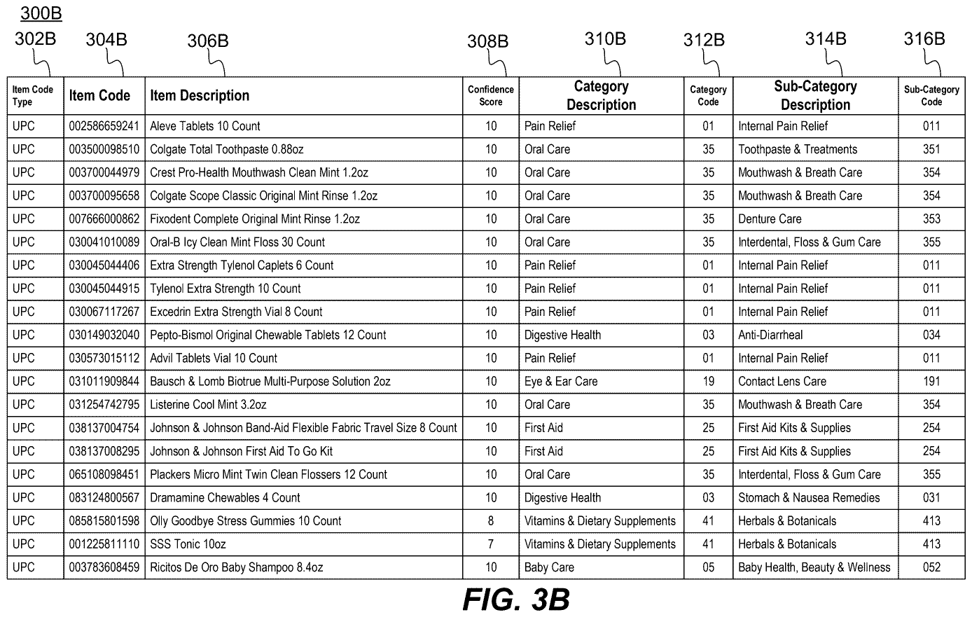

In some embodiments, the first data structure may include one or more of: a header, a delimiter, a retailer identifier, and a list of items. A header may refer to a section or portion of a file or data structure that contains metadata and/or control information. For example, a header may include information identifying or labeling the data stored in the file or data structure. By way of non-limiting example, a header may identify one or more of: an item code, an item code type, an item description, a category description, category code, a subcategory description, or a subcategory code. A delimiter may refer to a character or sequence of characters used to separate distinct elements within a string, list, or data structure. For example, a delimiter may include a comma, a semicolon, a vertical bar or pipe, a space, a tab, or any other suitable character. A retailer identifier may refer to a unique identifier associated with a retailer. One example of a first data structure in a non-standardized format is described and exemplified below with respect to FIG. 3A.

In some embodiments, each element or row in the list of items may include one or more data values, including: an item code, an item code type, an item description, a category description, category code, a subcategory description, or a subcategory code. An item code may include a price look-up code (PLU), universal product code (UPC), stock keeping unit (SKU), European article number (EAN), a random weight system 2 code, a retailer-specific code, or any other means of cataloging or defining an item using an identifier (e.g., alphanumeric sequence). An item code type may specify a format or nature of an item code. For example, an item code type may be “UPC” for an item whose item code is in the UPC format. Further, an item code type may be “CUSTOM” for an item whose item code is in a retailer-specific code. An item description may refer to a name or textual representation of the item. A category description may refer to a name of a broad category of products. A category code may refer to an identifier assigned to the category description and may be shorter than the category description. For example, a category code may be “BB” for an item in the “Bread & Bakery” category. A subcategory description may refer to a name of a narrower category of products under a broader category. A subcategory code may refer to an identifier assigned to the subcategory description and may be shorter than the subcategory description. For example, a subcategory code may be “075” for an item in the “Bread” subcategory.

In some embodiments, the first data structure may include one of: a flat file, a text file, a fixed-length file, a comma-delimited file, or a pipe-delimited file. A flat file may refer to a database or data storage format that consists of records or data stored in a plain text format, typically with one record per line. A text file may refer to a file that contains human-readable text. A fixed-length file may refer to a file that stores data in fields of predetermined length. A comma-delimited file may refer to a file in which data values are separated by commas (i.e., “,”). A pipe-delimited file may refer to a file in which data values are separated by vertical bars or pipes (i.e., “|”). In general, it may be understood that the first data structure may include any suitable file format that stores and/or structures data in a particular way. For example, any number of retailers may send a respective first data structure having a different (e.g., non-standardized) data format. In some embodiments, processing device 101 may be configured to store the first data structure in a memory. For example, processing device 101 may be configured to store any number of first data structures (e.g., all, only most recent) received from a retailer in a memory (e.g., of processing device 101, database 107). In some embodiments, the memory may store one or more operating systems that perform known operating system functions when executed by the processor. By way of example, the operating system may include Microsoft Windows, Unix, Linux, Android, Mac OS, iOS, or other types of operating systems. Accordingly, examples of the disclosed invention may operate and function with computer systems running any type of operating system. The memory may be a volatile or non-volatile, magnetic, semiconductor, tape, optical, removable, non-removable, or other type of storage device or tangible computer readable medium.

In some embodiments, processing device 101 may receive the first data structure at a predetermined interval. For example, when the first data structure is a catalog update file, a retailer may send, to processing device 101, a catalog update file once every two weeks, once every month, once every quarter, or any other suitable time period. Additionally or alternatively, in some embodiments, processing device 101 may receive the first data structure when a retailer has an update. For example, a retailer using client device 105 may send, to processing device 101, a catalog update file each time the retailer updates their own item catalog (e.g., adding or updating products and/or services).

In some embodiments, processing device 101 may be configured to validate a received first data structure. Validating a data structure may include one or more of a structural validation, a schema validation, and a referential validation. A structural validation may refer to ensuring a file or data structure adheres to an expected format. For example, processing device 101 may be configured to perform a structural validation, including ensuring a file or data structure uses the expected delimiter (e.g., comma, pipe). A schema validation may refer to ensuring the data in each field matches a defined schema. For example, processing device 101 may be configured to perform a schema validation, including ensuring, when the item code type is “UPC,” that the data for each item in the item code field conforms to the UPC format (e.g., 12-digit number). A referential validation may refer to ensuring data relationships and/or dependencies are valid. For example, processing device 101 may be configured to perform a referential validation, including ensuring each item is associated with a different item code.

In some embodiments, processing device 101 may be configured to generate an exception file for an item that does not pass a validation test. For example, if the first data structure contains three items with 11-digit item codes of item code type UPC, processing device 101 may generate an exception file flagging the three items with 11-digit codes as potentially invalid for the associated item code type (e.g., processing device 101 may determine if any item of the first data structure includes an error and may include each of those items in the exception file). In such examples, flagging an item may include including the item in an exception file, and the presence of the item in the exception file may indicate that the item may contain an error. Additionally or alternatively, the exception file may include an error value (e.g., “TRUE” or “1”) for each included item indicating that the item has an error. Processing device 101 may store the generated exception file in a memory (e.g., as described above, database 107). In some embodiments, processing device 101 may prompt a user to perform a review of a generated exception file. For example, processing device 101 may output a prompt (e.g., visual prompt on a display operatively connected to processing device 101) and/or may transmit a signal (e.g., to client device 105) indicating that one or more items may contain an error. In general, flagging an item or data structure may involve adding a digital marker or flag to the item or data structure such that the item or data structure may be queried or identified and/or may involve creating a separate data structure or file to store the flagged items.

In some embodiments, processing device 101 may be configured to determine a map between the first data structure and a second data structure stored in a database. In some embodiments, the second data structure may include a master catalog. A master catalog may refer to a centralized repository containing a comprehensive list of all items associated with any participating retailer. For example, a master catalog may contain a list of all products and/or services provided by all retailers associated with system 100. In some embodiments, the master catalog may be stored in a memory. For example, the master catalog may be stored in a memory of processing device 101 and/or database 107. Additionally or alternatively, the master catalog may be stored in a cloud-based storage system.

In some embodiments, a map may refer to a function that converts a value from one format, structure, or domain to another. Additionally or alternatively, in some embodiments, a map may refer to a dictionary or collection of key-value pairs. In one example, processing device 101 may be configured to determine a map between the first data structure comprising data associated with a non-standardized format (e.g., retailer-specific) and the second data structure comprising data associated with a standardized format (e.g., operator of processing device 101-specific). The determined map may be configured to associate each datum or value associated with each item in the first data structure of a non-standardized format with a datum or value associated with the same item of a standardized format of the second data structure. In another example, when the first data structure is a catalog update file, processing device 101 may determine a map from the non-standardized format to the standardized format by determining if a map associated with the retailer sending the first data structure is stored in a memory. Processing device 101 may retrieve the map from a memory (e.g., of processing device 101, database 107) or query a database for the corresponding map. By way of non-limiting example, processing device 101 may be configured to determine a map between the first data structure comprising data associated with a non-standardized format (e.g., retailer-specific) and the second data structure comprising data associated with a standardized format (e.g., operator of processing device 101-specific) using a computer algorithm, machine learning algorithm (e.g., by machine learning system 103), heuristic, or any other suitable method known to those skilled in the art.

In some embodiments, each item in the first data structure may be associated with fewer data values than an item in the standardized data format. For example, the first data structure may include only an item description, an item code, and an item code type (e.g., as depicted in FIG. 3A). In such embodiments, mapping may include converting (e.g., by processing device 101 and/or machine learning system 103) the item description, the item code, and the item code type from the non-standardized format to the standardized format. Further, mapping may include determining (e.g., by processing device 101 and/or machine learning system 103) a value in the standardized format for other data values for the item, such as category code and subcategory code, as further described and exemplified further below.

By way of non-limiting example, the first data structure may include items in a non-standardized format, such as having an item code type of “EAN,” and the second data structure may include items in a standardized format, such as having an item code type of “UPC.” In such an example, mapping may include processing device 101 receiving a first data structure with items of item code type “EAN” and, using a predetermined map stored in a memory (e.g., of processing device 101, database 107), converting the items of the first data structure to item code type “UPC.”

In another example, the first data structure may include items in a retailer-specific format, e.g., item code type “CUSTOM”, obscure or unintelligible item description (e.g., different language, having many non-obvious abbreviations). In such an example, processing device 101 may transmit the first data structure to machine learning system 103. Machine learning system 103 may be configured to determine, using a machine learning model, a third data structure (e.g., as depicted in FIG. 3B). The machine learning model may be configured to determine a human-readable item description, an item code in a standardized format, a category description, a category code, a sub-category description, a sub-category code, and a confidence score (further discussed below). Further, processing device 101 and/or machine learning system 103 may be configured to store a mapping between the retailer-specific (e.g., non-standardized) item code and the standardized item code in a memory (e.g., of processing device 101, database 107). The stored mapping may be associated with the particular retailer and may be used by processing device 101 to convert further received first data structures (e.g., catalog update) to a third data structure in a standardized format.

In some embodiments, processing device 101 may be configured to determine a configuration file. For example, after validating the first data structure and determining the map, processing device 101 may be configured to store, in a memory (e.g., of processing device 101, database 107) a configuration file including the one or more validation tests and the determined map between the non-standardized data format of the first data structure and the standardized data format of the second data structure. In some embodiments, processing device 101 may be configured to determine a configuration file for each different retailer. For example, processing device 101 may, after receiving a first data structure, determine a corresponding, stored configuration file associated with the sender of the first data structure (e.g., retailer using client device 105) based on an identified formatting of the first data structure and may use the corresponding configuration file to validate the first data structure.

In some embodiments, processing device 101 may be configured to convert, based on a determined map, each item of a set of items to a standardized format. For example, processing device 101 may be configured to use the determined map to convert each datum or value for each item of the first data structure from their respective non-standardized format to the standardized data format of the second data structure. By way of non-limiting example, processing device 101 may be configured to convert an item code of the first data structure from a non-standardized format (e.g., PLU code) to a standardized product code of the second data structure (e.g., UPC code).

In embodiments in which the first data structure is an initial full catalog file or a delta catalog update file, processing device 101 may be configured to convert each the values of each item of the first data structure from their non-standardized format to a standardized format. For example, processing device 101 may be configured to perform a detailed analysis of each item in the first data structure by validating the first data structure. Further, processing device 101 may be configured to identify each item that contains retailer-specific data. For example, processing device 101 may be configured to associate a retailer tag with each item that contains retailer-specific item codes (e.g., PLU), random weight items, or any other associated data that appears to be valid but exists in a non-standard range. A retailer tag may refer to an additional data value for an item labeling or indicating which retailer sent the first data structure including that item. For example, a retailer tag may be an alphanumeric value that is the as or an abbreviation of the retailer's name. Alternatively, a retailer tag may be an alphanumeric value that is associated with a retailer, and a reference table (e.g., map, library, dictionary, data structure) stored in a memory (e.g., of processing device 101, database 107). Processing device 101 may add or append the retailer tag to each item identified as containing retailer-specific data in the third data structure.

In some embodiments, processing device 101 may be configured to generate an exception file flagging each item with a retailer tag for further review. For example, processing device 101 may generate an exception file (e.g., file, data structure) comprising each item with a retailer tag in the third data structure and may store the exception file in a memory (e.g., of processing device 101, database 107). In some embodiments, the further review may include a manual review by a person or an artificial intelligence-based review (e.g., supervised, unsupervised by machine learning system 103). Processing device 101 may be configured to convert the items in the first data structure to the standardized format using a determined map and to store the converted items in a third data structure. Processing device 101 may add or incorporate the items included in the exception file in the third data structure after the further review.

In embodiments in which the first data structure is a full catalog update file, processing device 101 may be configured to determine which items are updated by comparing the received first data structure with a previously received first data structure. For example, processing device 101 may be configured to compare a received full catalog update file with the most recently received full catalog update file or initial full catalog file associated with the same retailer. Processing device 101 may flag any new items or items with at least one different value for conversion and may store the flagged items in a modified first data structure in a memory (e.g., of processing device 101, database 107). In some embodiments, processing device 101 may use the modified first data structure as a delta catalog update file. For example, processing device 101 may be configured to convert each item in the modified first data structure from a non-standardized format to standardized format stored in a third data structure.

In some embodiments, processing device 101 may be configured to determine a difference between a third data structure and a second data structure. For example, processing device 101 may be configured to compare the third data structure comprising data converted to the standardized format to a master catalog. In some embodiments, processing device 101 may be configured to generate one or more fourth data structures. For example, processing device 101 may be configured to generate a fourth data structure including new candidate product records for each item in the third data structure that does not exist or have a corresponding item in the second data structure. Further, processing device 101 may be configured to generate another fourth data structure including retailer-specific updates to the second data structure for each item in the third data structure that has a corresponding item in the second data structure. It may be understood that a single fourth data structure may include both new items and updated items.

In some embodiments, processing device 101 may be configured to determine a first update to the fourth data structure. For example, processing device 101 may be configured to perform an Application Programming Interface (API) call to request information (e.g., product description) for each item of the fourth data structure. The API may include any API configured to provide product details based on an item code or other identifying code. Further, processing device 101 may be configured to determine a recommended category code and subcategory code for each item in the first difference data structure. For example, based on the received information from the API call, processing device 101 may determine a category code and a subcategory code for each item in the fourth data structure in the standardized format. Processing device 101 may be configured to modify the fourth data structure based on the received information and/or recommended category code and subcategory code and may update the fourth data structure accordingly.

In some embodiments, processing device 101 may be configured to determine a second update to the fourth data structure. For example, processing device 101 may be configured to command a machine learning model (e.g., of machine learning system 103) to determine information for each item of the fourth data structure. Machine learning system 103 may be configured to determine a value for each datum associated with each item in the fourth data structure and to output the determined values as an updated fourth data structure. Further, processing device 101 may be configured to generate an exception file flagging each item determined (e.g., by machine learning system 103) to require further review, as exemplified and described further below.

In some embodiments, processing device 101 may be configured to update a second data structure based on the updated fourth data structure. For example, processing device 101 may be configured to update each corresponding item in the master catalog with the update data stored in the updated fourth data structure.

In some embodiments, processing device 101 may be configured to update the second data structure each time a first data structure is received. For example, each time a retailer sends a catalog update file, processing device 101 may be configured to determine an updated fourth data structure and update the master catalog based on the updated fourth data structure (e.g., on-demand update).

Additionally or alternatively, in some embodiments, processing device 101 may be configured to update the second data structure at a predetermined interval. For example, processing device 101 may be configured to update the master catalog after a predetermined number (e.g., 5, 10, 100, or any other suitable number) of updated fourth data structures are determined (e.g., after a predetermined number of first data structures are received) or after a predetermined time has passed (e.g., biweekly, monthly, quarterly). By way of non-limiting example, processing device 101 may update the second data structure using one updated fourth data structure at a time (e.g., sequential update). Alternatively, processing device 101 may update the second data structure using each collected fourth data structure at a same time (e.g., simultaneous update). Further, processing device 101 may combine each updated fourth data structure into a single combined data structure, and may use the single combined data structure to update the second data structure at the predetermined interval, which may decrease processing time. In this way, a fewer number of update processes are performed compared to an on-demand update embodiment, which may be leveraged to utilize downtime during peak operating times and to increase the efficiency and performance of processing device 101. By way of non-limiting example, processing device 101 may be configured to run a timed job that executes on a periodic basis, such as by using a Linux scheduler or any other suitable method known to those skilled in the art.

In some embodiments, processing device 101 may be configured to send data to other devices in system 100, such as client device 105, machine learning system 103, or the like. For example, processing device 101 may send the fourth data structure to machine learning system 103. Further, processing device 101 may be configured to send the second data structure to a retailer. In one example, a retailer (e.g., client device 105) may access the master catalog while performing a transaction to determine item-level eligibility for a spending program (e.g., for basket adjudication). In another example, a retailer may use the master catalog as an item catalog for the retailer to manage and organize the products and/or services provided by the retailer.

In some embodiments, processing device 101 may be configured to receive data from other devices in system 100, such as client device 105 or machine learning system 103, or the like. For example, processing device 101 may receive an output of the machine learning model from machine learning system 103. Further, processing device 101 may receive an initial catalog file or catalog update file from client device 105.

In some embodiments, processing device 101 may be configured to create a training dataset for a machine learning model. For example, processing device 101 may be configured to create a training dataset including historical received first data structures, the corresponding determined maps, the corresponding updated fourth data structures, or any combination of the foregoing. Further, processing device 101 may be configured to clean and/or normalize the created training dataset by tokenizing the data values of each item. For example, processing device 101 may be configured to break down each item into tokens (e.g., each data value is a token). Processing device 101 may be configured to map each unique token to a unique integer (e.g., token ID) and to embed the token IDs into a corresponding dense vector representation (e.g., via an embedding layer). In this way, the training dataset may comprise a matrix or set of vectors, which may be utilized by a machine learning model to identify relationships between tokens.

Machine learning system 103 represents one or more electronic devices that provide functionality for a making predictions, decisions, or inferences based on data. Machine learning system 103 may include or one or more known processing devices, such as, for example, a microprocessor. In some embodiments, machine learning system 103 may include any type of single or multi-core processor, mobile device microcontroller, central processing unit, or any circuitry that performs logic operations.

In operation, machine learning system 103 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in machine learning system 103, or elsewhere. Machine learning system 103 may be configured to receive input data from other devices such as processing device 101, client device 105, and the like.

Machine learning system 103 may be configured to execute computer instructions for one or more machine learning models. A machine learning model refers to a computational model or algorithm that is trained to perform a specific task without being explicitly programmed for that task using learned patterns and relationships to make predictions or decisions. In some embodiments, the machine learning model may be implemented as a large language model, such as GPT-3, GPT-4, BERT, XLNet, or any other suitable large language model. Large language model refers to a type of machine learning model designed to analyze, to understand, and to generate human-like language via natural language processing tasks.

In some embodiments, machine learning system 103 may be configured to train machine learning model using the training dataset created by processing device 101. In some embodiments, the machine learning model is a supervised large language model. For example, the training dataset may include labeled data, such as the first data structure, the determined map, and/or the updated fourth data structure. In some embodiments, the machine learning model is a semi-supervised large language model. For example, the machine learning model may be primarily trained on unlabeled data (e.g., the first data structure, the determined map) and then fine-tuned in a supervised manner. In some embodiments, the machine learning model is an unsupervised large language model. For example, the machine learning model may may be trained using a training dataset including the first data structure and/or the determined map.

In some embodiments, machine learning system 103 may be configured to train machine learning model to determine data values for items in a standardized format. For example, machine learning system 103 may be configured to train the machine learning model to determine for each item one or more of an item code, an item code type, an item description, a category description, category code, a subcategory description, or a subcategory code. By utilizing machine learning system 103 to determine data values for items in a standardized format, processing device 101 is not reliant on performing an API call to determine data values for items in the standardized format. While an API call can provide information regarding data values for items in the standardized format, an API may be static and require updates, which can lead to deprecation or out-of-date information. Leveraging machine learning system 103 to perform and/or to assist determination of data values for items in a standardized format may provide a more robust mapping from the non-standardized format of the first data structure (e.g., catalog update file) to the standardized format of the second data structure (e.g., electronic catalog).

In some embodiments, the machine learning model may be configured to determine a human-readable item description for each item. For example, the first data structure may include items with an item description containing many abbreviations (e.g., due to character restrictions), which may be difficult for a human to understand what the associated product or service is. The machine learning model may be trained to determine an unabbreviated version of the item description, which may be readily understandable to a human user.

In some embodiments, the machine learning model may be configured to determine a category code or subcategory code for each item. For example, the machine learning model may be trained to determine a category code and a subcategory code in the standardized format for each item, including items that did not have a category code or subcategory code in the first data structure. The category code and/or subcategory code may be used to determine eligibility according to one or more program rules for a spending program.

In some embodiments, the machine learning model may be trained to provide or produce an explanation associated with an output. The machine learning model may be trained to produce an output or response when given an input as a result of training. The training may involve natural language processing tasks, such as recognizing the context and information presented in an input, implementing artificial intelligence logic and reasoning, comparing or contrasting different potential outputs, or the like. The machine learning model may further be trained to produce an explanation of an output based on the natural language processing tasks that the machine learning model performs. For example, the explanation for each determined value may include an explanation generated by the machine learning model explaining why the machine learning model determined the values in the updated fourth data structure.

In some embodiments, the machine learning model may be configured to determine an accuracy score associated with the update. For example, the machine learning model may be trained to output an accuracy score indicating a confidence or likelihood that the determined updates are accurate. When the accuracy score for an update for an item is below a predetermined threshold, the machine learning model may flag the item for further review. In some embodiments, an accuracy score may be based on at least one of an adherence of the input data to expected values, a number or type of transformations performed, a number of non-transformational inferences, or other any other suitable factors known to those skilled in the art. For example, an accuracy score may be based on a number of items converted to the standardized format (e.g., number of transformations performed) and/or a number of items determined as already being in the standardized format (e.g., number of non-transformational inferences).

Machine learning system 103 may be configured to receive data from other devices, such as processing device 101, client device 105, or the like. For example, machine learning system 103 may receive a fourth data structure from processing device 101. Machine learning system 103 may use the fourth data structure as an input to the machine learning model. The machine learning model may be configured to, based on the training, determine an updated fourth data structure including data in the standardized format.

Machine learning system 103 may be configured to send data to other devices, such as processing device 101, client device 105, or the like. For example, machine learning system 103 may send the output of the machine learning model to processing device 101.

Client device 105 represents a computing device configured to perform one or more processes consistent with the disclosed embodiments. For example, client device 105 may be implemented as a notebook computer, a mobile device with computing ability, a desktop computer, tablet, a point-of-sale (POS) device, or the like. Client device 105 may include a visual display, such as a screen, touchscreen, monitor, or the like, that may display information to a user. Client device 105 may communicate with processing device 101 using a wireless network, a mobile network, a satellite network, or the like. Generally, it may be understood that any of the devices illustrated in FIG. 1 may communicate with any other device illustrated in FIG. 1 using a wireless network, mobile network, a satellite network, a physical data line, or the like. In operation, client device 105 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in client device 105, or elsewhere.

In some embodiments, client device 105 may be configured to receive data from a user. For example, the data may include a catalog file (e.g., initial catalog file, catalog update file). The user (e.g., retailer) may input the catalog file to client device 105 for transmission to processing device 101. Further, client device 105 may be configured to access the second data structure. For example, client device 105 may be configured to query database 107 for the second data structure during a transaction to determine item-level eligibility for a spending program.

In some embodiments, client device 105 may be configured to send data to another device, such as processing device 101 or machine learning system 103. For example, client device 105 may send the first data structure (e.g., initial catalog file, catalog update file) to processing device 101.

Database 107 represents one or more devices configured to store data. A database may refer to an electronic filing system that stores data in a structured way. Examples of databases may include relational databases, NoSQL databases, graph databases, in-memory databases, or the like. Database 107 may be, in some embodiments, a device storing data in one or more of a relational database, a non-relational database, a flat file, a CSV (comma separated value) file, a Microsoft Excel file, or the like.

In some embodiments, database 107 may be configured to store data. In operation, database 107 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in database 107, or elsewhere.

In some embodiments, database 107 may be configured to store the second data structure. For example, database 107 may be configured to store the master catalog. Additionally or alternatively, database 107 may be configured to store a previously received first data structure. For example, database 107 maybe configured to store the last-processed catalog file for each retailer. In this way, processing device 101 may query database 107 for the last-processed catalog file for a retailer after receiving a new catalog update file from the retailer to determine new and/or updated items. In some embodiments, database 107 may be configured to store the training dataset. For example, database 107 may be configured to store the training dataset and/or testing dataset used to train machine learning system 103.

Network 109 represents an electronic network for transmitting data between electronic devices. Network 109 may be implemented as one or more of the Internet, an intranet, a private link (such as a fiber optic network connecting remote sites), or the like. Network 109 may comprise wired links, wireless links, or a combination of wired and wireless links between the devices in system 100 (as well as other, unpictured devices).

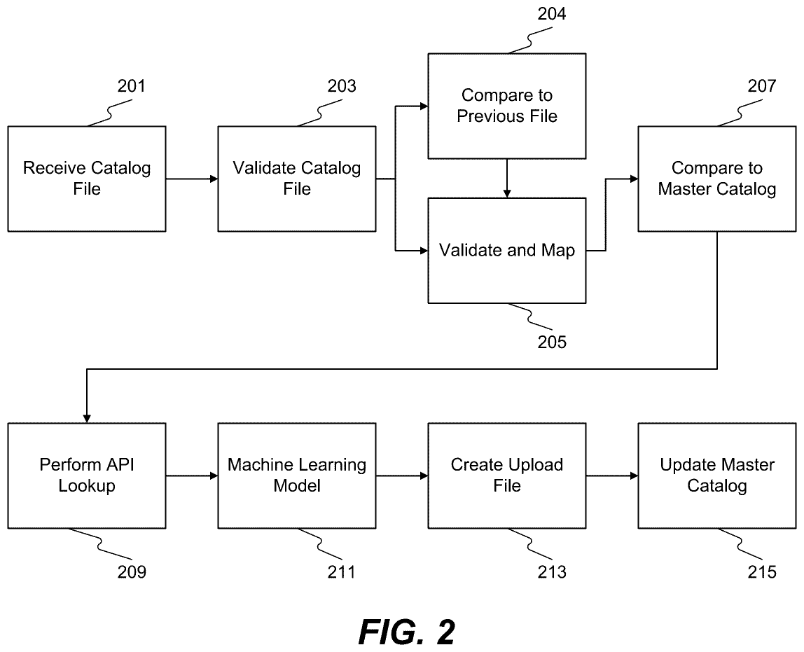

FIG. 2 is an example process for catalog management, consistent with disclosed embodiments. In general, it may be understood that two or more of the below-described steps may take place simultaneously or in a different order to accomplish a same or similar end result. Additionally or alternatively, certain steps may be combined, removed, or repeated.

In step 201, at least one processor may receive a catalog file. For example, processing device 101 may receive a first data structure from client device 105. The first data structure may include an initial catalog file or a catalog update file. One non-limiting example of a first data structure is depicted in FIG. 3A.

In step 203, at least one processor may validate the catalog file. For example, processing device 101 may validate the structure and/or consistency of the received catalog file to ensure the catalog file is in the expected non-standardized format associated with the corresponding retailer for client device 105. In some embodiments, the first time processing device 101 receives a first data structure (e.g., initial full catalog file) from a retailer (e.g., using client device 105), processing device 101 may be configured to identify the format of the received first data structure and may store the identified format as the expected format for that retailer in a memory (e.g., of processing device 101, database 107). In this way, processing device 101 and/or database 107 may store each expected format for each respective retailer for validation of all subsequently received first data structures (e.g., catalog update file).

In one example, processing device 101 may be configured to validate the catalog file using the item code of at least one item in the received catalog file. If the item code does not match an expected format for the respective retailer (e.g., different item code type, different item code length), processing device 101 may identify the received catalog file as potentially having an error and may generate an output (e.g., to a user of processing device 101, to client device 105) indicating the received catalog file potentially has an error. In this way, processing device 101 may be able to accept a wide variety of formats—including retailer-specific or custom data formats—for catalog files without requiring the catalog file to be in a standardized format.

In step 204, at least one processor may compare the catalog file to a previous catalog file. For example, when the received first data structure is a full catalog update file, processing device 101 may be configured to compare the received catalog update file with the previously received catalog file to determine which items are new and/or updated. Processing device 101 may be configured to create a delta catalog update file based on the determined new and/or updated items. In some embodiments, processing device 101 may skip step 204 when the received first data structure is an initial catalog file or a delta catalog update file.

In step 205, at least one processor may validate and map the catalog file to the standardized data format. For example, processing device 101 may be configured to validate the catalog file to ensure the data integrity corresponds to a stored configuration file associated with the retailer. Further, processing device 101 may map each item in the catalog file from the non-standardized format to the standardized format in a third data structure. In some embodiments, at least one processor may be configured to generate an exception file for each item that does not pass the one or more validation tests. For example, processing device 101 may flag each item in the catalog file that includes data in an unexpected data format (e.g., erroneous data, data format not associated with the retailer) and may store the flagged items in an exception file for further review (e.g., manually by a user, automatically by a machine learning model) (e.g., processing device 101 may determine if any item of the catalog file includes an error and may flag each item including the error).

In step 207, at least one processor may compare the third data structure to the master catalog. For example, processing device 101 may compare each item in the third data structure, which are the standardized data format, to the master catalog to determine which items are new and/or updated. Processing device 101 may store the differences in a fourth data structure.

In step 209, at least one processor may perform an API lookup for each item in the fourth data structure. For example, processing device 101 may perform an API lookup to determine one or more updates to the fourth data structure, including updates to the item description, item category code, item subcategory code, or any other data value for an item stored in the fourth data structure.

In step 211, at least one processor may determine an update to the fourth data structure using a machine learning model. For example, processing device 101 may use the updated fourth data structure from step 209 as an input into a trained machine learning model to determine further updates to the fourth data structure. Because of the training, the machine learning model may determine more accurate or useful updates to the fourth data structure than in step 209. By utilizing both an API lookup and the machine learning model, each item in the fourth data structure can be updated to include more accurate information, including an item description, category code, or subcategory code in the standardized format. One non-limiting example of an updated fourth data structure is depicted in FIG. 3B.

In step 213, at least one processor may create an upload file. For example, processing device 101 may be configured to create an updated fourth data structure including all new and/or updated items with the updated data values in the standardized format. In some embodiments, a new item may include an item with an item description not present in the second data structure. For example, processing device 101 and/or machine learning system 103 may be configured to determine an accuracy score for each item in the updated fourth data structure. If the item description does not match an item description in the master catalog and the accuracy score is at or above a predetermined threshold, then the item may be included in the upload file. If the item description does not match an item description in the master catalog and the accuracy score is at or below a predetermined threshold, then the item may be flagged for further review. Based on the further review (e.g., manual review by a user, automated review by a machine learning model), the item may be included in the upload file.

In step 215, at least one processor may update the master catalog using the upload file. For example, processing device 101 may be configured to update the master catalog using the upload file (i.e., updated fourth data structure) to replace the data values for items in both the second data structure and the upload file (e.g., remove item description for an item in the second data structure and add item description for the item from the updated fourth data structure) and/or to add items present in only the updated fourth data structure and their data values (e.g., item description, item code) to the second data structure. In some embodiments, processing device 101 may be configured to update the master catalog each time an upload file is created. Additionally or alternatively, in some embodiments, processing device 101 may be configured to update the master catalog after a predetermined number of upload files are created (e.g., each associated with a different retailer) or at a predetermined interval (e.g., weekly, biweekly, monthly, quarterly, yearly). In some embodiments, processing device 101 may only update the master catalog in response to manual confirmation by a user. For example, a user may manually review and submit the upload file for updating the master catalog. Additionally or alternatively, in some embodiments, processing device 101 may update the master catalog without manual confirmation by a user.

Creating intermediate data structures during the catalog update process may allow each step of the update process to be reviewed. In this way, errors can be detected and associated with a particular step, which may help identify faulty steps for fixing.

FIG. 3A is an example diagram of a first data structure, consistent with disclosed embodiments. As shown in FIG. 3A, first data structure 300A may include a header identifying an item code 302A and an item description 304A. Although first data structure 300A depicts only item code 302A and item description 304A, it may be understood that a first data structure received from a retailer (e.g., via client device 105) may include any number of at least one column of information.

As depicted in FIG. 3A, first data structure 300A includes items in a retailer-specific item code type (e.g., “CUSTOM”) and with an abbreviated item description that may be difficult for a human to interpret without assistance.

FIG. 3B is an example diagram of an updated fourth data structure, consistent with disclosed embodiments. As shown in FIG. 3B, updated fourth data structure 300B may include a header identifying an item code 302B, an item description 304B, a confidence score 306B, a confidence score 308B, a category description 310B, a category code 312B, a sub-category description 314B, and a sub-category code 316B.

Machine learning system 103 may be configured, using a machine learning model, to generate third data structure 300B based on inputted first data structure 300A. As depicted in FIG. 3B, each item is converted to a standardized format, such as the item code type to “UPC”, the item code to a UPC item code, and a human-readable item description. Further, machine learning system 103 has determined a category description 310B, a category code 312B, a sub-category description 314B, and a sub-category code 316B. In some embodiments, category description 310B, category code 312B, sub-category description 314B, and sub-category code 316B may correspond to categories of a spending program and may be used (e.g., by processing device 101, a point-of-sale system associated with a retailer) to determine item eligibility for the spending program. Machine learning system 103 may also determine a confidence score 308B for each item indicating the accuracy of the conversion to the standardized format.

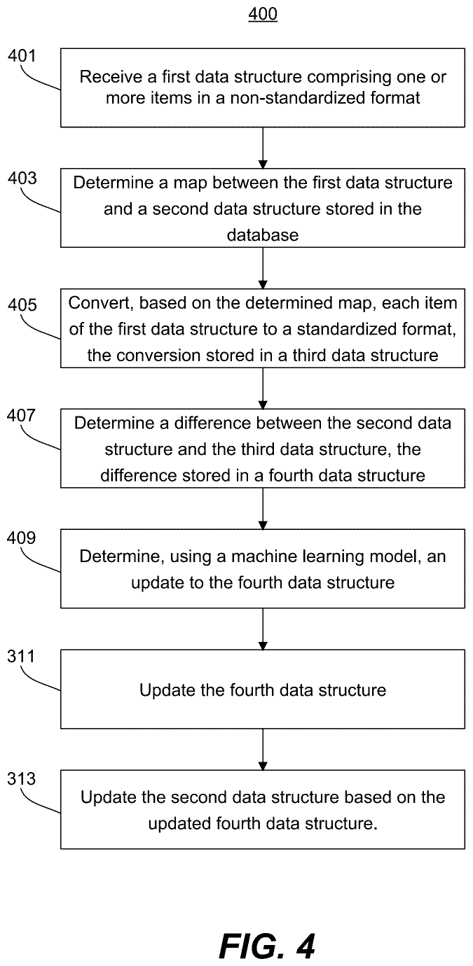

FIG. 4 is a flowchart for an example catalog management method, consistent with disclosed embodiments. In general, it may be understood that two or more of the below-described steps may take place simultaneously or in a different order to accomplish a same or similar end result. Additionally or alternatively, certain steps may be combined, removed, or repeated.

In step 401, at least one processor may receive a first data structure comprising one or more items in a non-standardized format. For example, processing device 101 may receive a catalog file (e.g., initial catalog file, catalog update file) from client device 105.

In step 403, at least one processor may determine a map between the first data structure and a second data structure stored in a database. For example, processing device 101 may perform an API call to or may query a database (e.g., database 107) storing items (e.g., products, services) and corresponding item codes (e.g., UPC, EAN). In such an example, processing device 101 may determine a map from the non-standardized data format associated with the client device 105 to the standardized data format associated with the second data structure by finding an item description in the database that matches or corresponds to the item description in the first data structure and retrieving a corresponding item code in the standardized format. The map may include a one-to-one correspondence from an item code in the non-standardized format (e.g., retailer-specific PLU code) to an item code in the standardized format (e.g., UPC code).

In step 405, at least one processor may convert, based on the determined map, each item of the first data structure to a standardized format, the conversion stored in a third data structure. For example, processing device 101 may be configured to map each item in the received catalog file from the non-standardized format associated with the retailer to the standardized format associated with the master catalog.

In step 407, at least one processor may determine a difference between the second data structure and the third data structure, the difference stored in a fourth data structure. For example, processing device 101 may compare the third data structure and the second data structure to determine new items (e.g., present in third data structure and not present in second data structure) and updated items (e.g., present in both third data structure and second data structure but having at least one different data value). Processing device 101 may store the new and updated items in a fourth data structure.

In step 409, at least one processor may determine, using a machine learning model, an update to the fourth data structure. For example, machine learning system 103 may be configured to determine an updated item description, an updated category code, an updated subcategory code, and an accuracy score for each item in the fourth data structure. The updated item description may include a human-readable item description. The updated category and updated subcategory codes may categorize the item. By way of non-limiting example, the updated category and subcategory codes may be used by one or more program rules associated with a spending program to determine item-level eligibility for the spending program. For example and with reference to FIG. 3B, a category code “35” corresponding to the category “oral care” and an associated subcategory code “351” corresponding to the sub-category “toothpaste & treatments” may be used to determine an item's eligibility for a spending program (e.g., can be at least partially purchased using the spending program). In such examples, a point-of-sale device or client device 105 of a retailer may query processing device 101 for the second data structure (e.g., catalog) to determine which items (e.g., products, services) provided by the retailer may be eligible for a spending program (e.g., operated by the retailer, operated by the owner of processing device 101). Non-limiting example of a spending program and item eligibility determination are described in U.S. application Ser. No. 18/504,801 filed on Nov. 8, 2023, and U.S. application Ser. No. 18/817,018 filed on Aug. 7, 2024, the entire contents of both of which are incorporated herein. Further, non-limiting examples of implementations relating to spending programs and item eligibility determinations are described in U.S. Provisional Application No. 63/790,450 filed on Apr. 17, 2025, and U.S. application Ser. No. 19/182,408 filed on Apr. 17, 2025, the entire contents of both of which are incorporated herein.

In step 311, at least one processor may update the fourth data structure. For example, processing device 101 may update the fourth data structure based on the updates determined by machine learning system 103. One example of an updated fourth data structure is depicted in FIG. 3B.

In step 313, at least one processor may update the second data structure based on the updated fourth data structure. For example, processing device 101 may update the master catalog to include the new items in the updated fourth data structure. Further, processing device 101 may update existing items in the master catalog based on the updated data values associated with the items of the updated fourth data structure.

Certain features which, for clarity, are described in this specification in the context of separate embodiments may also be provided in combination in a single embodiment. Conversely, various features which, for brevity, are described in the context of a single embodiment may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

The term “processor,” as used herein, refers to one or more processors. The disclosed systems may be implemented in part or in full on various computers, electronic devices, computer-readable media (such as CDs, DVDs, flash drives, hard drives, or other storage), or other electronic devices or storage devices. The methods and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). While disclosed processes include particular process flows, alternative flows or orders are also possible in alternative embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of . Net Framework, . Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented method for updating a database, comprising:
receiving a first data structure comprising one or more items in a non-standardized format;
determining a map between the first data structure and a second data structure stored in the database;
converting, based on the determined map, each item of the first data structure to a standardized format, the conversion stored in a third data structure;
determining a difference between the second data structure and the third data structure, the difference stored in a fourth data structure;
determining, using a machine learning model, an update to the fourth data structure;
updating the fourth data structure; and
updating the second data structure based on the updated fourth data structure.

2. The computer-implemented method of claim 1, wherein the first data structure includes one of: a flat file, a text file, a fixed-length file, a comma-delimited file, or a pipe-delimited file.

3. The computer-implemented method of claim 1, further comprising:
determining a configuration associated with a sender of the first data structure based on an identified formatting of the first data structure; and
storing the determined map and the determined configuration in the database.

4. The computer-implemented method of claim 1, wherein determining the update includes determining a standardized category.

5. The computer-implemented method of claim 4, further comprising:
determining a sub-category.

6. The computer-implemented method of claim 1, further comprising:
creating a training dataset for the machine learning model including the first data structure and the determined map; and
training the machine learning model based on the training dataset.

7. The computer-implemented method of claim 1, wherein the machine learning model is configured to determine an accuracy score associated with the update.

8. The computer-implemented method of claim 7, further comprising:
in response to determining the accuracy score is below a predetermined threshold, flagging the update.

9. The computer-implemented method of claim 1, further comprising:
determining if any item of the first data structure includes an error; and
flagging each item including the error.

10. The computer-implemented method of claim 1, wherein determining the difference includes at least one of:
performing an application programming interface (API) call to request information for each item of the difference; or
commanding the machine learning model to determine information for each item of the difference.

11. The computer-implemented method of claim 1, wherein updating the second data structure occurs:
each time the first data structure is received, or after a predetermined number of data structures are received.

12. A system for updating a database, comprising:
at least one processor; and
at least one non-transitory computer-readable medium containing instructions that, when executed by the system, cause the system to perform operations comprising:
receiving a first data structure comprising one or more items in a non-standardized format;
determining a map between the first data structure and a second data structure stored in the database;
converting, based on the determined map, each item of the first data structure to a standardized format, the conversion stored in a third data structure;
determining a difference between the second data structure and the third data structure, the difference stored in a fourth data structure;
determining, using a machine learning model, an update to the fourth data structure;
updating the fourth data structure; and
updating the second data structure based on the updated fourth data structure.

13. The system of claim 12, wherein the first data structure includes one of: a flat file, a text file, a fixed-length file, a comma-delimited file, or a pipe-delimited file.

14. The system of claim 12, wherein the operations further comprise:
determining a configuration associated with a sender of the first data structure based on an identified formatting of the first data structure; and
storing the determined map and the determined configuration in the database.

15. The system of claim 12, wherein determining the update includes determining a standardized category.

16. The system of claim 15, wherein the operations further comprise:
determining a sub-category.

17. The system of claim 12, wherein the operations further comprise:
creating a training dataset for the machine learning model including the first data structure and the determined map; and
training the machine learning model based on the training dataset.

18. The system of claim 12, wherein the machine learning model is configured to determine an accuracy score associated with the update.

19. The system of claim 18, wherein the operations further comprise:
in response to determining the accuracy score is below a predetermined threshold, flagging the update.

20. The system of claim 12, wherein the operations further comprise:
determining if any item of the first data structure includes an error; and
flagging each item including the error.

21. The system of claim 12, wherein determining the difference includes at least one of:
performing an application programming interface (API) call to request information for each item of the difference; or
commanding the machine learning model to determine information for each item of the difference.

22. The system of claim 12, wherein updating the second data structure occurs: each time the first data structure is received, or after a predetermined number of data structures are received.

23. A non-transitory computer-readable medium storing code for updating a database, the code comprising instructions executable to:
receive a first data structure comprising one or more items in a non-standardized format;
determine a map between the first data structure and a second data structure stored in the database;
convert, based on the determined map, each item of the first data structure to a standardized format, the conversion stored in a third data structure;
determine a difference between the second data structure and the third data structure, the difference stored in a fourth data structure;
determine, using a machine learning model, an update to the fourth data structure;
update the fourth data structure; and
update the second data structure based on the updated fourth data structure.

24. The non-transitory computer-readable medium of claim 23, wherein the first data structure includes one of: a flat file, a text file, a fixed-length file, a comma-delimited file, or a pipe-delimited file.

25. The non-transitory computer-readable medium of claim 23, wherein the instructions are further executable to:
determine a configuration associated with a sender of the first data structure based on an identified formatting of the first data structure; and
store the determined map and the determined configuration in the database.

26. The non-transitory computer-readable medium of claim 23, wherein determining the update includes determining a standardized category.

27. The non-transitory computer-readable medium of claim 26, wherein the instructions are further executable to:
determine a sub-category.

28. The non-transitory computer-readable medium of claim 23, wherein the instructions are further executable to:
create a training dataset for the machine learning model including the first data structure and the determined map; and
train the machine learning model based on the training dataset.

29. The non-transitory computer-readable medium of claim 23, wherein the machine learning model is configured to determine an accuracy score associated with the update.

30. The non-transitory computer-readable medium of claim 29, wherein the instructions are further executable to:
in response to determining the accuracy score is below a predetermined threshold, flag the update.

31. The non-transitory computer-readable medium of claim 23, wherein the instructions are further executable to:
determine if any item of the first data structure includes an error; and
flag each item including the error.

32. The non-transitory computer-readable medium of claim 23, wherein determining the difference includes at least one of:
perform an application programming interface (API) call to request information for each item of the difference; or
command the machine learning model to determine information for each item of the difference.

33. The non-transitory computer-readable medium of claim 23, wherein updating the second data structure occurs: each time the first data structure is received, or after a predetermined number of data structures are received.
